(19) United States
(12) Patent Application Publication
(10) Pub. No.: US 2026/0061557 A1
(43) Pub. Date: Mar. 5, 2026

(54) SLURRY DELIVERY METHOD

(71) Applicant: Applied Materials, Inc., Santa Clara, CA (US)

(72) Inventors: Hari Soundararajan, Sunnyvale, CA (US); Shou-Sung Chang, Mountain View, CA (US); Haosheng Wu, San Jose, CA (US); Jianshe Tang, San Jose, CA (US); Takashi Fujikawa, San Jose, CA (US)

(21) Appl. No.: 18/820,021

(22) Filed: Aug. 29, 2024

(51) Int. Cl. B24B 57/02; B05D 1/02

(52) U.S. Cl. CPC B24B 57/02; B05D 1/02

(57) ABSTRACT

A method of polishing includes mixing a carrier gas and a slurry to form a polishing mixture, aerosolizing the polishing mixture onto a surface of a polishing pad, and creating relative motion between the polishing pad and a substrate to polish the substrate.

### TECHNICAL FIELD

The present disclosure relates to chemical mechanical polishing, and more particularly to slurry delivery in chemical mechanical polishing.

### BACKGROUND

An integrated circuit is typically formed on a substrate by the sequential deposition of conductive, semiconductive, or insulative layers on a silicon wafer. One fabrication step involves depositing a filler layer over a non-planar surface and planarizing the filler layer. For certain applications, a conductive filler layer is planarized until the top surface of a patterned layer is exposed. For other applications, such as oxide polishing, the filler layer is planarized until a predetermined thickness is left over the non-planar surface. In addition, planarization of the substrate surface is usually required for photolithography.

Chemical mechanical polishing (CMP) is one accepted method of planarization. This planarization method typically requires that the substrate be mounted on a carrier or polishing head. The exposed surface of the substrate is typically placed against a rotating polishing pad. The carrier head provides a controllable load on the substrate to push it against the polishing pad. A polishing liquid is typically supplied to the surface of the polishing pad.

### SUMMARY

In general, an aspect disclosed herein is a method of controlling polishing, mixing a carrier gas and a slurry to form a polishing mixture; aerosolizing the polishing mixture onto a surface of a polishing pad; and creating relative motion between the polishing pad and a substrate to polish the substrate.

Examples may include one or more of the following features. The carrier gas can be compressed dry air. The polishing mixture can be dispensed onto the surface in a conic spray having an axis of symmetry at an angle with respect to a normal axis of an upper surface of the polishing pad. The polishing mixture can be mixed immediately prior to dispensing the polishing mixture. The polishing mixture can be dispensed at a flow rate that is less than 200 cubic centimeters per minute. The polishing mixture can be dispensed at a flow rate that is less than 80 cubic centimeters per minute. Mixing may include mixing the carrier gas and the slurry while the carrier gas is at a pressure of less than 50 pounds per square inch. The relative motion between the polishing pad and the substrate can define a trailing edge of the substrate and the polishing mixture can be dispensed onto the surface behind the trailing edge.

In general, an aspect disclosed herein is a polishing system, including a platen to support a polishing pad; a carrier head to hold a substrate; a motor to generate relative motion between the platen and the carrier head; a port; a slurry supply line in fluid communication with the port; and a gas supply line in fluid communication with the slurry supply line, and configured to mix a carrier gas from the gas supply line and a polishing liquid from the slurry supply line to form a polishing mixture to be dispensed from the port.

Examples may include one or more of the following features. The port can have an open bore of 0.25 inches. The gas supply line can be in fluid communication with the slurry supply line immediately prior to the port; The system may include a slurry delivery arm supporting the port, the slurry supply line, and the gas supply line. The relative motion between the polishing pad and the substrate can define a trailing edge of the substrate and the slurry delivery arm can be arranged such that the port dispenses the polishing mixture onto a surface of the polishing pad behind the trailing edge.

Implementations may optionally include, but are not limited to, one or more of the following advantages.

An aerosolized slurry mixture reduces slurry usage per wafer thereby generating less waste and increasing the efficiency of a polishing process on a per wafer basis. Using less slurry in each process increases overall polishing pad life due to less pad conditioning. Dispensing the aerosolized slurry enables “in-time” slurry delivery at a porous level without excess slurry. Pressurized aerosol delivery of slurry reduces the accumulation of dried abrasive particles on the dispensing supply port, which improves polishing quality by reducing scratches and defects. The productivity of the polishing system is improved because less time is devoted to cleaning waste slurry from the port and polishing pad.

The details of one or more implementations are set forth in the accompanying drawings and the description below. Other aspects, features, and advantages will be apparent from the description and drawings, and from the claims.

### BRIEF DESCRIPTION OF THE DRAWINGS

FIG. 1 is a schematic cross-sectional view of a polishing system that includes a slurry delivery arm.

FIG. 2 is a schematic top view of various components of the polishing system.

FIGS. 3A and 3B are schematic diagrams of a side view of the slurry delivery arm.

FIG. 4 is a flow chart diagram showing steps in a slurry delivery method.

FIG. 5 is a bar chart comparing normalized removal rate over multiple test settings.

Like reference numbers and designations in the various drawings indicate like elements.

### DETAILED DESCRIPTION

For chemical mechanical polishing, a conventional approach for slurry delivery is to dispense slurry from a single port. Pumps or other pressurized flow control devices have traditionally been used to dispense slurry onto the platen from the single port. The quantity, flow rate, and pattern of the dispensed slurry is an important parameter for the CMP process. In general, a high flow rate of 200 cubic centimeters (cc) per minute (min) has traditionally been used in conventional CMP processes to that there is sufficient slurry to reach all of the substrate for the polishing process. However, this causes the slurry to be one of the major components in CMP cost-of-ownership on a per wafer basis. However, a portion of the liquid slurry dispensed onto the polishing surface of the pad is blocked by the retaining ring of the carrier head and does not reach the wafer, and consequently travels to a waste drain without being utilized in the CMP process.

Disclosed herein is an aerosolized slurry delivery method in which a liquid slurry containing a mixture of abrasive particulates and solvent chemicals is mixed with a carrier gas. By using the carrier gas to create a slurry aerosol, a lower volume of slurry (as compared to a conventional liquid flow technique) can be delivered onto the polishing pad while still achieving broad coverage of the pad with slurry. The reduced delivery volume reduces the wasted liquid slurry on the upper surface of the polishing pad and blocked away by the retaining ring. However, the reduced delivery volume of slurry is still transported to the substrate being polishing in the pores and grooves in the polishing surface on the top of the pad. The aerosolized slurry enables reduced slurry volume distribution per unit area thereby reducing slurry usage per wafer. Moreover, this can be accomplished without significant loss in the polishing rate, and thus without lowering throughput.

As used herein, the term ‘aerosol’ refers to a suspension of liquid droplets suspended in a carrier gas. The size of the liquid droplets within the carrier gas determines the ‘coarseness’ of the aerosol, which can be defined as a ‘coarse’ aerosol or a ‘fine’ aerosol. A coarse aerosol indicates a larger median, or average, size of the droplets than a fine aerosol. The size of the droplets can be defined by a median, or average, diameter or volume of individual droplets.

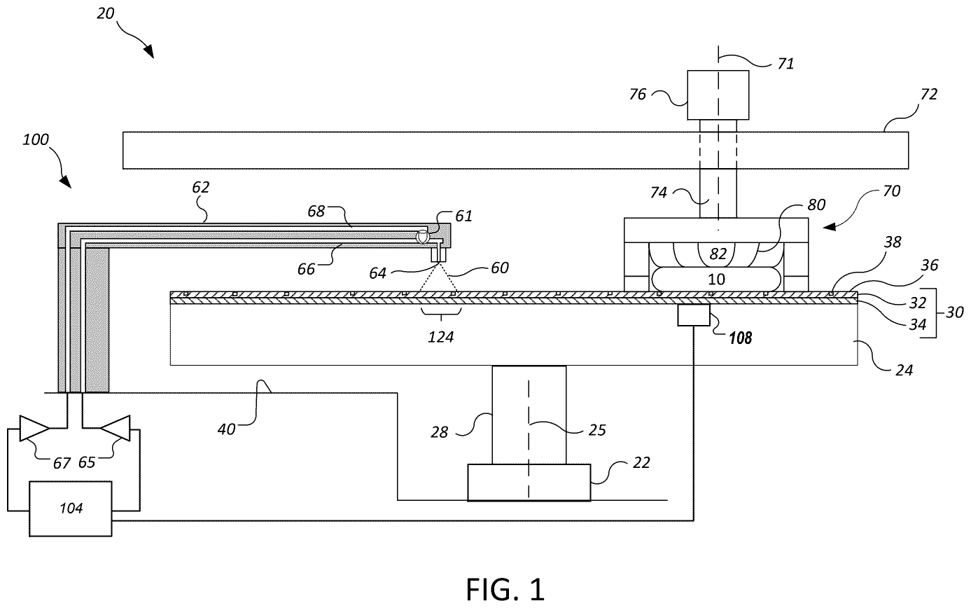

FIG. 1 shows a polishing system 20 operable to polish a substrate 10. The polishing system 20 includes a rotatable platen 24, on which a polishing pad 30 is situated. The platen 24 is operable to rotate about an axis 25. For example, a motor 22 can turn a drive shaft 28 to rotate the platen 24. The polishing pad 30 can be a two-layer polishing pad with an outer polishing layer 32 having a polishing surface 36 and a softer backing layer 34.

The polishing layer 32 can be micro-porous, e.g., include porous cells, such as bubbles or hollow microspheres. At the polishing surface, porous cells can form small recesses which can carry slurry. Pad conditioning can expose the porous cells which can contribute to slurry transfer to areas under the wafer during polishing. Aerosolized slurry can fill these porous cells efficiently reducing the time between dispensing and transfer beneath the wafer, thus enabling “in-time” slurry delivery.

The polishing system 20 includes a carrier head 70 operable to hold the substrate 10 against the polishing pad 30. The carrier head 70 can include a flexible membrane 80 having a substrate mounting surface to contact the back side of the substrate 10, and a plurality of pressurizable chambers 82 to apply different pressures to different zones, e.g., different radial zones, on the substrate 10. The carrier head 70 is suspended from a support structure 72, for example, a carousel or track, and is connected by a carrier drive shaft 74 to a carrier head rotation motor 76 so that the carrier head can rotate about an axis 71. In addition, the carrier head 70 can oscillate laterally across the polishing pad 30, e.g., by moving in a radial slot in the carousel 72 as driven by an actuator, by rotation of the carousel as driven by a motor, or movement back and forth along the track as driven by an actuator. In operation, the platen 24 is rotated about its central axis 25, and the carrier head 70 is rotated about its central axis 71 and translated laterally across the top surface of the polishing pad 30.

The polishing system 20 includes a slurry dispenser 100 to apply slurry to the polishing pad 30 at a controllable flow rate. The dispenser 100 includes a supply port 64, e.g., at the end of a slurry supply arm 62, to dispense a polishing mixture 60, such as an aerosolized slurry, onto the polishing pad 30. The arm 62 extends over the platen 24 and polishing pad 30 from an edge of the polishing pad 30 the center of polishing pad 30, to or at least near the center (e.g., within 5% of the total radius of the polishing pad 30).

The arm 62 can be supported by a base that includes one or more actuators, e.g., a linear actuator to raise or lower the arm 62, and/or a rotational actuator to swing the arm 62 laterally over the platen 24. The base can be supported on the same frame 40 as the platen 24. The arm 62 is positioned to avoid colliding with other hardware components such as the polishing head 70.

The slurry dispenser 100 uses a pressurized gas mixed with liquid slurry to dispense a polishing mixture 60 as an aerosolized spray of liquid slurry droplets. To produce the aerosolized mixture 60 from the nozzle 64, the arm 62 includes or supports a slurry supply line 66 connected to a slurry source 65 and a gas supply line 68 connected to a gas source 67.

The slurry source 65 provides liquid slurry to the slurry supply line 66. The gas source 67 supplies a pressurized gas, e.g., a gas above atmospheric pressure, to the gas supply line 68. In one example, the gas is air, such as dry air (e.g., compressed dry air). In another example, the gas is a mixture of air and another gas, such as an inert gas, such as nitrogen. The gas source 67 delivers the pressurized gas to the gas supply line 68 in a pressure range from 5 pounds per square inch (psi) to 50 psi (e.g., 30 psi). The slurry source 65 delivers liquid slurry to the slurry supply line 66 at a flow rate of less than or equal to 200 cc/min (e.g., less than or equal to 150 cc/min, less than or equal to 100 cc/min, or less than or equal to 50 cc/min).

The slurry supply line 66 and the gas supply line 68 are in fluid connection with a junction 61 in which the pressurized gas from the gas supply line 68 and the liquid slurry from the slurry supply line 66 are mixed to form the polishing mixture 60. The polishing mixture 60 is dispensed from the supply port 64 in an aerosolized spray, e.g., a suspension of slurry droplets in the carrier gas, onto a zone 124 on the outer polishing layer 32 of the polishing pad 30. In some examples, the supply port 64 has a cylindrical opening, e.g., an open bore. In one such instance, the supply port 64 has a ¼θ (6.35 mm) inner diameter (ID) opening.

Dispensing the slurry in an aerosolized mixture 60 permits reduction of the quantity of liquid slurry used over time during a polishing operation, while also delivering the mixture 60 over a wider zone 124 as compared to delivery of slurry in a liquid stream. Further, the polishing rate of the substrate 10 does not change when the aerosolized mixture 60 is used compared to using higher quantities of liquid slurry. Using lower quantities of slurry at the same rate of polishing beneficially increases the polishing efficiency and reduces slurry waste.

To produce the aerosolized spray, the pressurized gas in the gas supply line 68 mixes with the liquid slurry at the junction 61 which determines the aerosol characteristics when the aerosolized mixture 60 is dispensed onto the polishing pad 30. In general, higher gas pressure results in a finer mist than lower pressures in which the size of the slurry droplets is smaller.

Conversely, lower gas pressure results in a more coarse aerosol than higher pressures in which the size of the slurry droplets is larger.

The junction 61 is near the supply port 64 in the slurry dispensing arm 62. The junction 61 being proximate the supply port 64 reduces the chances of slurry buildup, or clogging, at the supply port 64 by enabling a lower pressure drop at the supply port 64 compared to embodiments in which the junction 61 is distant, e.g., further from, the supply port 64. In some instances, the junction 61 is within 10 cm of the supply port 64 (e.g., within 6 cm, within 4 cm).

The arm 62 can include or support one or more ports 64, e.g., nozzles, through which the slurry is dispensed, e.g., sprayed, onto the polishing pad 30. While FIG. 1 illustrates a single arm 62, there could be multiple arms; similarly, while FIG. 1 illustrates a single supply port 64, there could be multiple ports 64 dispensing the mixture 60 at different, or partially overlapping zones 124.

The system 20 includes a controller 104 which is in connection with the slurry source 65, the gas source 67, and an in-situ monitoring system 108. The in-situ monitoring system 108 monitors a thickness of an overlaying layer on the substrate 10 being polished. During the polishing operation the controller 104 receives thickness values of an overlying layer from the in-situ monitoring system 108 and compares the thickness value to a threshold. When the thickness value achieves the threshold, the controller 104 terminates the polishing process.

Examples of the in-situ monitoring system 108 include an optical, eddy current, or acoustic monitoring system. The in-situ monitoring system 108 shown in FIG. 1 is arranged in a recess in the platen 24 beneath the polishing pad 30. Some examples also include optical or acoustic windows in one or more layers of the polishing pad 30. In some examples, the controller 104 receives information on the thickness of the overlying layer and causes the slurry flow rate to change based on the thickness. In one example, the controller 104 determines a polishing rate for the overlying layer and changes the slurry flow rate based on the polishing rate. In another example, the controller 104 determines that periodic changes in the polishing rate (e.g., polishing rate “stuttering”), e.g., cause by insufficient quantity of slurry on the pad) are present, and change the slurry flow rate based on the presence of the periodic changes. For example, by increasing the slurry flow rate to compensate for the stuttering.

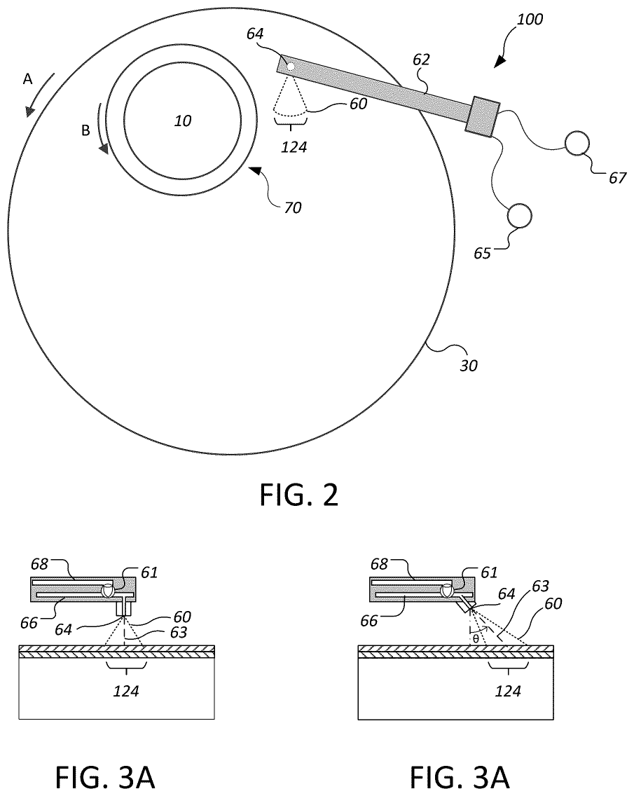

An overhead view of the polishing pad 30 and slurry dispensing arm 62 is shown in FIG. 2 along with the carrier head 70, the arm 62 extending over the polishing pad 30 from an edge. Along the direction of rotation of the platen 24 (arrow A), the arm 62 of the slurry control system 100 is in a ‘trailing’ position of the carrier head 70. In this instance, ‘trailing’ is used to indicate that the zone 124 on which the mixture 60 is dispensed is positioned before the carrier head 70 such that as the platen 24 rotates, the mixture 60 is dispensed onto the zone 124 and carried on the surface of the polishing pad 30 to the carrier head 70. As measured about the axis of rotation of the platen 24, the dispensing port on the arm 62 can be within 120°, e.g., within 60°, of the carrier head 70.

The polishing surface of the polishing layer 32 of the polishing pad 30 can include grooves 38 for transporting slurry and other process fluids and byproducts of the polishing process. The grooves 38 can be circular grooves that are concentric with the axis of rotation, a rectangular grid, etc.

Once the mixture 60 contacts the outer polishing layer 32, the droplets of the aerosol can coalesce into a liquid slurry. In another example if flow rate is low, the droplets of the aerosol may be on the top surface of the outer polishing layer 32 in droplet form which can then flow into the grooves 38 and coalesce into liquid slurry. The liquid slurry flows into the grooves and as the platen 24 rotates the polishing pad 30 the slurry in the grooves is transported beneath the retaining ring of the carrier head 70 and into contact with the substrate 10. Positioning the zone 124 in a trailing position dispenses the mixture 60 immediately prior to the carrier head 70 according to the platen 24 rotation direction, A, thus reducing the time during which the liquid slurry may defuse into the grooves potentially to a liquid level that is below the depth of the grooves.

The mixture 60 can be dispensed from the supply port 64 at non-zero angles with respect to the axis normal to the polishing surface 36. The mixture 60 being dispensed in a conic spray with an axis of symmetry parallel to the axis normal to the polishing surface 36 is shown in FIG. 3A, whereas the mixture 60 being dispensed in a conic spray with the axis of symmetry 63 at a non-zero angle θ relative to the normal axis is shown in FIG. 3B. Dispensing the mixture 60 at an angle θ can provide a wider zone 124 onto which the mixture 60 is dispensed. Distributing the mixture 60 over a wider zone 124 reduces the slurry density in a particular area of the zone 124 which can beneficially increase the slurry utilization and efficiency in the polishing process.

The slurry dispensing arm 62 can include or support an actuator which changes the angle, θ, at which the mixture 60 is dispensed. In such examples, the actuator is in communication with the controller 104 which determines at which θ the mixture 60 is dispensed. The controller 104 can have a mixture 60 dispensing recipe stored in a non-volatile medium and control the θ at which the mixture 60 is dispensed according to the recipe, or according to other commands received from the system 20 or a user.

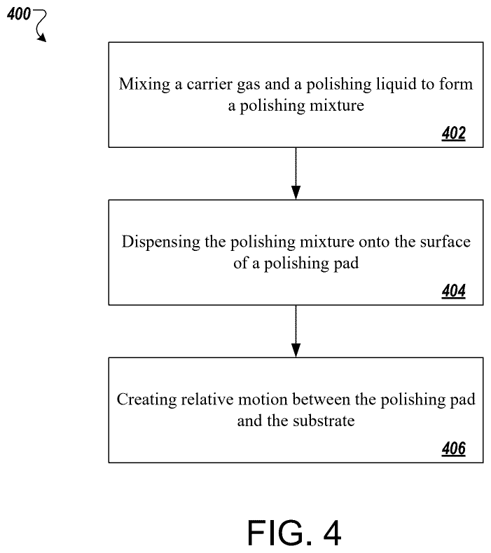

Referring to FIG. 4, disclosed herein is a method 400 for controlling polishing using an aerosolized spray of liquid slurry in a carrier gas. The system 20 and slurry control system 100 described herein are examples of systems which can perform the method 400.

A carrier gas and a polishing liquid are mixed to form a polishing mixture (402). In one example, the carrier gas and the polishing liquid are mixed in a junction to form a polishing mixture of liquid/gas suspension, e.g., a T-junction, or a Y-junction. The mixing can occur near a dispensing nozzle.

The polishing mixture is aerosolized onto the surface of a polishing pad (404). The polishing mixture with the entrained gas exits the dispensing nozzle and is aerosolized as the carrier gas escapes the polishing mixture. The liquid is dispensed in a mist of droplets, e.g., an aerosol, and is directed at the polishing pad on which the polishing operation is occurring.

Relative motion between the polishing pad and a substrate is created (406). In one example, a rotatable platen supporting the polishing pad is rotated by a motor around a central axis. Additionally or alternatively, a carrier head holding the substrate against the polishing pad rotates and/or translates to generate relative motion.

The polishing process is terminated when one or more termination criteria are met, such as a signal from a timer or an in-situ monitoring system indicating that a thickness of an overlying layer reaches a predetermined threshold.

A number of embodiments have been described. Nevertheless, it will be understood that various modifications may be made. Accordingly, other embodiments are within the scope of the following claims.

### EXAMPLES

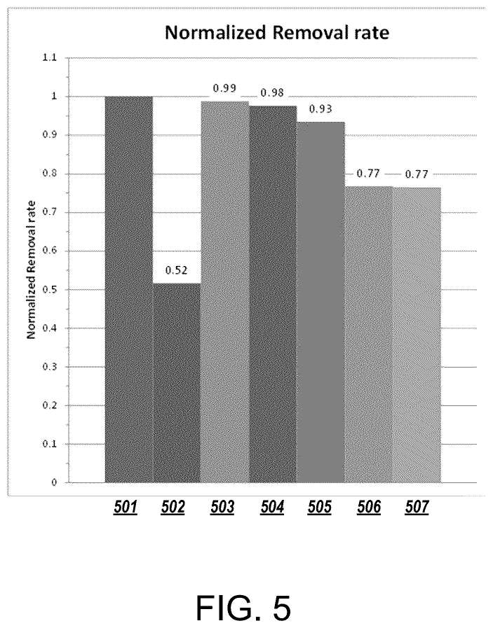

FIG. 5 shows a bar chart of several example polishing processes in which the normalized removal rate was determined. For all trials represented by columns 501-507, an overlying layer on a substrate was polished and the material removal rate was determined. For the trials represented by columns 501 and 502, the fluid slurry dispensing method was used at a fluid flow rate of 200 cc/min, and 50 cc/min, respectively. The removal rate for the trial represented by column 501 was normalized to a normalized removal rate value of 1 and used as a comparison against the other trails.

The normalized polishing rates for trials represented by columns 503-507 were determined using the aerosolized slurry dispensing method described herein. Columns 503-505 were performed at a lower carrier gas pressure than columns 506 and 507. The trial represented by column 503 used a fluid flow rate of 68 cc/min, the trail represented by column 504 used a fluid flow rate of 70 cc/min, a pressure of 30 psi, and the trail represented by column 505 used a fluid flow rate of 68 cc/min.

Columns 506 and 507 were performed using a higher carrier gas pressure than columns 503-505. The trial represented by column 506 used a fluid flow rate of 80 cc/min and the trial represented by column 507 used a fluid flow rate of 82 cc/min.

The highest normalized polishing rate by the aerosolized dispensing method was achieved in the trials represented by columns 503-505 utilizing the lower carrier gas pressure and a fluid flow rate of between 68 and 70 cc/min. The normalized polishing rates for the trails represented by columns 503-505 were within 7% of the trial represented by column 501 and used between 65% and 66% less slurry by flow rate.

What is claimed is:

1. A method of controlling polishing, comprising:
mixing a carrier gas and a slurry to form a polishing mixture;
aerosolizing the polishing mixture onto a surface of a polishing pad; and
creating relative motion between the polishing pad and a substrate to polish the substrate.

2. The method of claim 1, wherein the carrier gas is compressed dry air.

3. The method of claim 1, wherein the polishing mixture is dispensed onto the surface in a conic spray having an axis of symmetry at an angle with respect to a normal axis of an upper surface of the polishing pad.

4. The method of claim 1, wherein the polishing mixture is mixed immediately prior to dispensing the polishing mixture.

5. The method of claim 1, wherein the polishing mixture is dispensed at a flow rate that is less than 200 cubic centimeters per minute.

6. The method of claim 5, wherein the polishing mixture is dispensed at a flow rate that is less than 80 cubic centimeters per minute.

7. The method of claim 1, wherein mixing comprises mixing the carrier gas and the slurry while the carrier gas is at a pressure of less than 50 pounds per square inch.

8. The method of claim 1, wherein the relative motion between the polishing pad and the substrate defines a trailing edge of the substrate and the polishing mixture is dispensed onto the surface behind the trailing edge.

9. A polishing system, comprising:
a platen to support a polishing pad;
a carrier head to hold a substrate;
a motor to generate relative motion between the platen and the carrier head;
a port;
a slurry supply line in fluid communication with the port; and
a gas supply line in fluid communication with the slurry supply line, and configured to mix a carrier gas from the gas supply line and a polishing liquid from the slurry supply line to form a polishing mixture to be dispensed from the port.

10. The system of claim 9, wherein the port has an open bore having a diameter of less than 10 mm.

11. The system of claim 9, wherein the port has an open bore of 0.25 inches.

12. The system of claim 9, wherein the gas supply line is in fluid communication with the slurry supply line immediately prior to the port.

13. The system of claim 9, comprising a slurry delivery arm supporting the port, the slurry supply line, and the gas supply line.

14. The system of claim 13, wherein the relative motion between the polishing pad and the substrate defines a trailing edge of the substrate and the slurry delivery arm is arranged such that the port dispenses the polishing mixture onto a surface of the polishing pad behind the trailing edge.
